(19) United States
(12) Patent Application Publication
(10) Pub. No.: US 2010/0200650 A1
(43) Pub. Date: Aug. 12, 2010

(54) MOBILE COMMUNICATION DEVICE AND METHOD FOR RECOVERING MIFARE MEMORY

(75) Inventors: Alexandre Corda, Nice (FR); Ismaila Wane, Cannes (FR); Vincent Lemonnier, Nice (FR)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/670,691

(22) PCT Filed: Jul. 21, 2008
(86) PCT No.: PCT/IB08/52927

§ 371 Date: Jan. 26, 2010

(30) Foreign Application Priority Data
Aug. 1, 2007 (EP) 07290965.8
Jul. 21, 2008 (IB) PCT/IB2008/052927

(51) Int. Cl. G06F 17/00; G06F 12/00

(52) U.S. Cl. 235/375; 711/115; 711/E12.001

(57) ABSTRACT

A mobile communication device (1) is connectable to a classic or emulated MIFARE memory (MM) and a MIFARE applications manager (MAM). The MIFARE applications manager (MAM) is adapted to retrieve MIFARE applications (MIA) from the MIFARE memory (MM), to check whether they meet at least one validity criterion (CRIT1, 5 CRIT2) and to delete those MIFARE applications from the MIFARE memory (MM) that do not meet the validity criterion (CRIT1, CRIT2).

### FIELD OF THE INVENTION

The invention relates to a mobile communication device being connectable to a classic or emulated MIFARE memory.

The invention further relates to a method for managing MIFARE applications in a mobile communication device being connected to a classic or emulated MIFARE memory.

The invention further relates to a computer program product directly loadable into the memory of a mobile communication device being connectable to a MIFARE device.

The invention further relates to a mobile communication device being connectable to a classic or emulated MIFARE memory, wherein the mobile communication device is adapted to process the computer program product mentioned in the above paragraph.

### BACKGROUND OF THE INVENTION

The MIFARE® classic family, developed by NXP Semiconductors is the pioneer and front runner in contactless smart card ICs operating in the 13.56 MHz frequency range with read/write capability. MIFARE complies with ISO14443 A, which is used in more than 80% of all contactless smart cards today. The technology is embodied in both cards and card reader devices. MIFARE cards are being used in an increasingly broad range of applications (including transport ticketing, access control, e-payment, road tolling, and loyalty applications). MIFARE Standard (or Classic) cards employ a proprietary high-level protocol with a proprietary security protocol for authentication and ciphering.

The MIFARE Classic cards are fundamentally just memory storage devices, where the memory is divided into segments and blocks with simple security mechanisms for access control. Each device has a unique serial number. Anticollision is provided so that several cards in the field may be selected and operated in sequence.

The MIFARE Standard 1 k offers about 768 bytes of data storage, split into 16 sectors with 4 blocks of 16 bytes each (one block consists of 16 byte); each sector is protected by two different keys, called A and B. They can be programmed for operations like reading, writing, increasing value blocks, etc. The last block of each sector is called “trailer”, which contains two secret keys (A and B) and programmable access conditions for each block in this sector. In order to support multi-application with key hierarchy an individual set of two keys (A and B) per sector (per application) is provided.

The memory organization of a MIFARE Standard 1 k card is shown in FIG. 1. The 1024×8 bit EEPROM memory is organized in 16 sectors with 4 blocks of 16 bytes each. The first data block (block 0) of the first sector (sector 0) is the manufacturer block which is shown in detail in FIG. 2. It contains the serial number of the MIFARE card that has a length of four bytes (bytes 0 to 3), a check byte (byte 4) and eleven bytes of IC manufacturer data (bytes 5 to 15). The serial number is sometimes called MIFARE User IDentification (MUID) and is a unique number. Due to security and system requirements the manufacturer block is write protected after having been programmed by the IC manufacturer at production. However, the MIFARE specification allows to change the serial number during operation of the MIFARE card, which is particularly useful for MIFARE emulation cards like SmartMX cards.

SmartMX (Memory eXtension) is a family of smart cards that have been designed by NXP Semiconductors for high-security smart card applications requiring highly reliable solutions, with or without multiple interface options. Key applications are e-government, banking/finance, mobile communications and advanced public transportation.

The ability to run the MIFARE protocol concurrently with other contactless transmission protocols implemented by the User Operating System enables the combination of new services and existing applications based on MIFARE (e.g. ticketing) on a single Dual Interface controller based smart card. SmartMX cards are able to emulate MIFARE Classic devices and thereby makes this interface compatible with any installed MIFARE Classic infrastructure. The contactless interface can be used to communicate via any protocol, particularly the MIFARE protocol and self defined contactless transmission protocols. SmartMX enables the easy implementation of state-of-the-art operating systems and open platform solutions including JCOP (the Java Card Operating System) and offers an optimized feature set together with the highest levels of security. SmartMX incorporates a range of security features to counter measure side channel attacks like DPA, SPA etc. A true anticollision method (acc. ISO/IEC 14443-3), enables multiple cards to be handled simultaneously.

It should be noted that the emulation of MIFARE Classic cards is not only restricted to SmartMX cards, but there may also exist other present or future smartcards being able to emulate MIFARE Classic cards.

Recently, mobile communication devices have been developed which contain MIFARE devices, either being configured as MIFARE Classic cards or as MIFARE emulation devices like SmartMX cards. These mobile communication devices comprise e.g. mobile phones with Near Field Communication (NFC) capabilities, but are not limited to mobile phones.

While the ability of MIFARE Classic cards and MIFARE emulation devices to store multiple MIFARE applications (sometimes also referred to as “MIFARE Classic Objects) have boosted the worldwide propagation and acceptance of MIFARE memory devices (both classic and emulation types) the size limitation in MIFARE memories (usually 1 kB or 4 kB) have turned out to become a bottle neck in developing new MIFARE applications. This problems becomes even more severe with the development of large MIFARE applications that require more than one sector of a MIFARE memory to be stored therein. What is more, it frequently happens that sectors of a MIFARE memory are occupied by MIFARE applications that are no longer valid, but still reside in the memory, thereby blocking the installation of new MIFARE applications. Such invalid MIFARE applications comprise e.g. void coupons, expired tickets, invalid access controls, etc.

### OBJECT AND SUMMARY OF THE INVENTION

It is an object of the invention to provide a mobile communication device of the type defined in the opening paragraph and a method of the type defined in the second paragraph, in which the problems mentioned above are overcome.

In order to achieve the object defined above, with a mobile communication device according to the invention characteristic features are provided so that such a mobile communication device can be characterized in the way defined below, that is:

A mobile communication device being connectable to a classic or emulated MIFARE memory and a MIFARE applications manager being adapted to retrieve MIFARE applications from the MIFARE memory, to check whether they meet at least one validity criterion and to delete those MIFARE applications from the MIFARE memory that do not meet the validity criterion.

In order to achieve the object defined above, with a method according to the invention characteristic features are provided so that a method according to the invention can be characterized in the way defined below, that is:

A method for managing MIFARE applications in a mobile communication device that is connected to a classic or emulated MIFARE memory, the method comprising:

retrieving MIFARE applications from the MIFARE memory;

checking whether they meet at least one validity criterion; and

deleting those MIFARE applications from the MIFARE memory that do not meet the validity criterion.

In order to achieve the object defined above, a computer program product being directly loadable into the memory of a mobile communication device being connectable to a classic or emulated MIFARE memory comprises software code portions for performing—when running on the mobile communication device—the steps of the method for operating a mobile communication device according to the above paragraph.

In order to achieve the object defined above, a mobile communication device according to the invention comprises an arithmetic-logic unit and a memory and processes the computer program product according to the above paragraph.

The present invention allows to overcome the above problems in the environment of mobile communication devices, particularly in a NFC phone environment, by providing recovery of MIFARE memory by detecting and deleting invalid MIFARE applications.

The validity criterions that are applied in detecting invalid MIFARE applications comprise, but are not restricted to expiry dates, the numbers of remaining transactions or transits or the like, and/or remaining credits larger than zero.

In one embodiment of the invention the mobile communication device is preconfigured with at least one validity criterion.

In another embodiment of the invention the mobile communication device can be updated with validity criterions by adapting the mobile communication device to receive new validity criterions via a data connection (e.g. the Over The Air (OTA) service of a Mobile Telephone Service Provider, or a date network) from a remote server, e.g. a Trusted

Service Manager (TSM).

The present invention is perfectly suited for mobile phones with NFC capabilities that can be equipped with classic or emulated MIFARE devices, like SmartMX cards.

The aspects defined above and further aspects of the invention are apparent from the exemplary embodiments to be described hereinafter and are explained with reference to these exemplary embodiments.

### BRIEF DESCRIPTION OF THE DRAWINGS

The invention will be described in more detail hereinafter with reference to exemplary embodiments. However, the invention is not limited to them.

FIG. 1 shows the memory organization of a MIFARE Standard 1 k EEPROM.

FIG. 2 shows the manufacturer block of a MIFARE memory.

FIG. 3 shows the sector trailer of a sector of MIFARE memory.

FIG. 4 to FIG. 6 show a schematic diagram of an embodiment of a mobile communication device according to the present invention being equipped with a MIFARE memory as well as the various steps of carrying MIFARE memory recovery according to the invention.

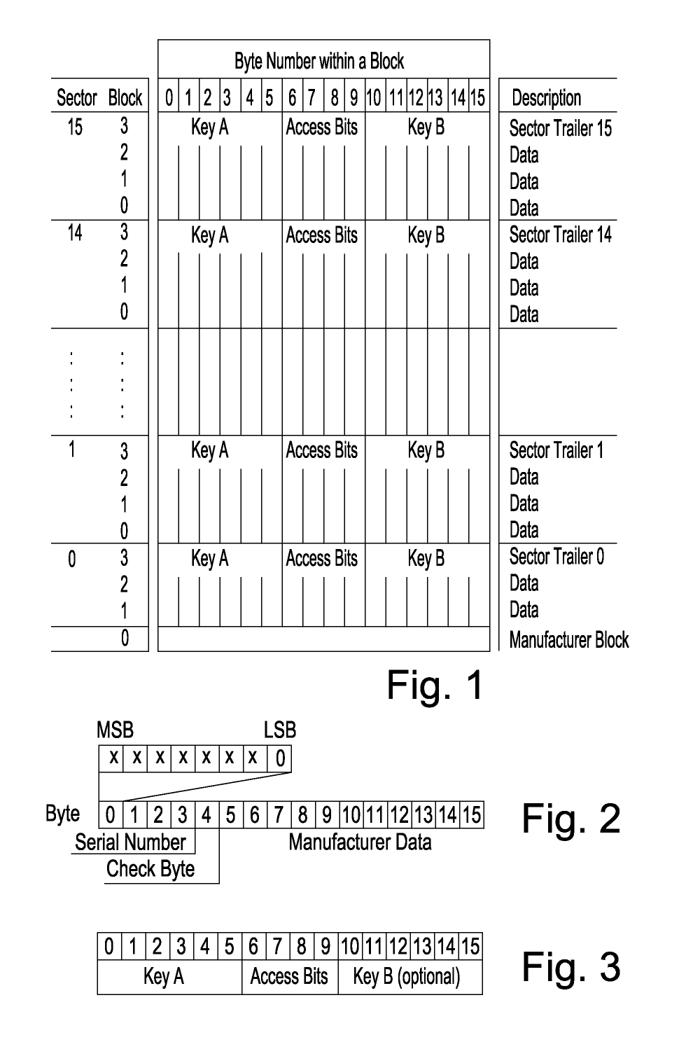

### DESCRIPTION OF EMBODIMENTS

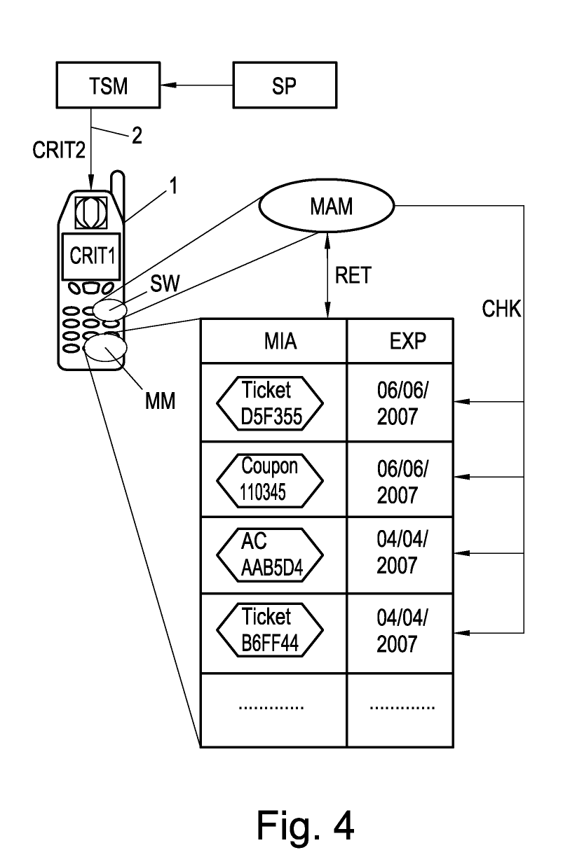

FIG. 4 shows a schematic representation of a mobile communication device 1 being configured as mobile phone with Near Field Communication (NFC) abilities. The mobile communication device 1 comprises a processor and memory (not shown in the drawing) for executing software SW. The software SW comprises an operating system for carrying out and managing all functions of the mobile communication device 1. The mobile communication device 1 is connectable to a MIFARE memory MM which can either be configured as a MIFARE Classic card or a MIFARE Emulation card. The term “connectable to” as used herein means that the MIFARE memory MM is either arranged in an integrated manner in the mobile communication device 1, e.g. being configured as a chip that is arranged on a circuit board of the mobile communication device 1, or the mobile communication device 1 comprises an interface for receiving the MIFARE memory MM in a removable manner which means that the MIFARE memory MM is configured as a card device.

According to the present invention the mobile communication device 1 comprises a MIFARE applications manager MAM. In the present embodiment of the invention the MIFARE applications manager MAM is a software module being contained in the software SW of the mobile communication device 1. The MIFARE applications manager MAM has the ability to retrieve (arrow RET) MIFARE applications MIA from the MIFARE memory MM, to check (arrow CHK) whether the retrieved MIFARE applications MIA meet at least one validity criterion CRIT1, CRIT2 and to delete (arrow DEL_AC) those MIFARE applications MIA from the MIFARE memory MM that do not meet the validity criterion CRIT1, CRIT2.

The MIFARE applications that are stored in the MIFARE memory MM typically comprise tickets, coupons and access controls (AC) as shown in FIG. 4. However, the MIFARE applications MIA are not restricted to said application types. In the present example all of the MIFARE applications MIA have an expiry date EXP that can be used as a validity criterion. As will be appreciated that expiry date EXP is the Jun. 6, 2007, except for the access control AC which has an expiry date EXP of Apr. 4, 2007. The expiry date, or generally any criterion of the MIFARE application MIA that may serve as a validity criterion may be stored in specific bytes of the MIFARE application in a form that is readable by the MIFARE applications manager MAM. There may be other bytes in the MIFARE application that serve as counters and can also be read and used by the MIFARE applications manager MAM in relation to validity criterions. For instance, the validity criterions are selected from expiry dates, the numbers of remaining transactions or transits or the like, remaining credits larger than zero, although this is not to be understood as an exhaustive list.

The MIFARE applications manager MAM checks the validity of each retrieved MIFARE application MIA by comparing specific portions of the MIFARE application with at least one validity criterion CRIT1, CRIT2. These validity criterions may be predefined criterions CRIT1 that are stored in the mobile communication device 1. However, validity criterions CRIT2 are also downloadable into the mobile communication device 1 via a data connection 2 from a remote server, e.g. a Trusted Service Manager TSM. Thereby, the MIFARE applications manager MAM is always provided with the latest validity criterions.

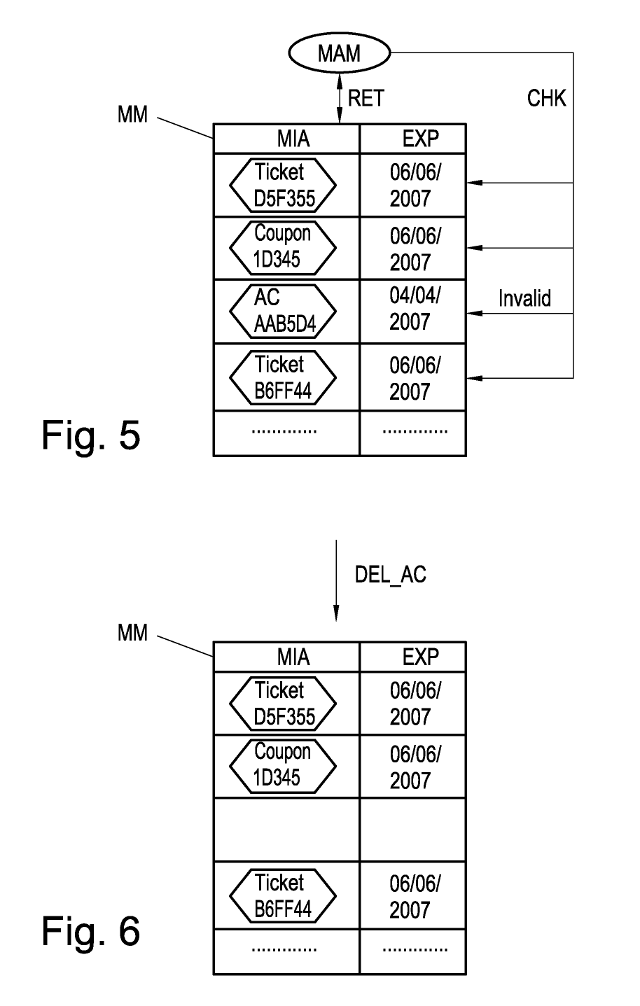

In the present example of the invention the MIFARE applications manager MAM uses the expiry date EXP of the MIFARE applications MIA as validity criterion. It is assumed that FIG. 4 shows a snapshot of the MIFARE memory MM as of Apr. 4, 2007. Hence, all MIFARE applications in MIFARE memory MM are valid. The situation changes on the next day, i.e. Apr. 5, 2007. FIG. 5 shows a snapshot of the MIFARE memory MM as of Apr. 5, 2007. As shown in FIG. 5 the MIFARE applications manager MAM detects that the access control AC MIFARE application has an expiry date that has lapsed the day before so that the access control AC has become invalid. Consequently, as represented by the arrow DEL_AC the access control AC is deleted from the MIFARE memory MM by the MIFARE applications manager MAM.

The result of the delete operation is shown in FIG. 6. It will be recognized that the sector of the MIFARE memory MM where previously the access control AC application had resided is now empty and ready for storing another MIFARE application.

MIFARE applications are loaded into the mobile communication device 1 e.g. by a Service Provider SP via the server TSM and the data connection 5 similar to the validity criterions CRIT2. The MIFARE applications manager MAM will handle correct storing of new MIFARE applications. Alternatively, new MIFARE applications are loaded by means of a NFC reader/writer when the mobile communication device 1 has NFC capabilities and is located within the range of such a NFC reader/writer.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The indefinite article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. A mobile communication device being connectable to a classic or emulated MIFARE memory and comprising a MIFARE applications manager adapted to retrieve MIFARE applications from a connected MIFARE memory, to check whether they meet at least one validity criterion and to delete those MIFARE applications from the MIFARE memory that do not meet the validity criterion.

2. The mobile communication device as claimed in claim 1, wherein at least one validity criterion is a predefined criterion that is stored in the mobile communication device.

3. The mobile communication device as claimed in claim 1, wherein at least one validity criterion is receivable by the mobile communication device via a data connection from a remote server.

4. The mobile communication device as claimed claim 1, wherein the validity criterion is chosen from the group consisting of expiry dates, the numbers of remaining transactions or transits or the like, remaining credits larger than zero.

5. The mobile communication device as claimed in claim 1, wherein the mobile communication device is a mobile phone.

6. A method for managing MIFARE applications in a mobile communication device that is connected to a classic or emulated MIFARE memory, the method comprising:
retrieving MIFARE applications from the MIFARE memory;
checking whether they meet at least one validity criterion; and
deleting those MIFARE applications from the MIFARE memory that do not meet the validity criterion.

7. The method as claimed in claim 6, wherein at least one validity criterion is a predefined criterion that is stored in the mobile communication device.

8. The method as claimed in claim 6, wherein at least one validity criterion is received by the mobile communication device via a data connection from a remote server.

9. The method as claimed in claim 6, wherein the validity criterion is chosen from the group consisting of an expiry date, the numbers of remaining transactions or transits or the like, a remaining credit larger than zero.

10. A computer program product being directly loadable into the memory of a mobile communication device that is connectable to a classic or emulated MIFARE memory, wherein the computer program product comprises software code portions for performing—when running on the mobile communication device—the steps of the method as claimed in claim 6.

11. The computer program product as claimed in claim 10, wherein the computer program product is stored on a computer readable medium or is downloadable from a remote server via a communication network.

12. A mobile communication device with an arithmetic-logic unit and a memory, wherein the mobile communication device is adapted to process the computer program product as claimed in claim 10.

13. The mobile communication device as claimed in claim 12, being configured as a mobile phone having NFC capabilities.
